(19) United States
(12) Patent Application Publication
(10) Pub. No.: US 2007/0019616 A1
(43) Pub. Date: Jan. 25, 2007

(54) Group formation using mobile computing devices

(76) Inventors: Olli Rantapuska, Vantaa (FI); Jari P. Kinnunen, Helsinki (FI); Mikko Lonnfors, Helsinki (FI); Pekka A. Kuismanen, Helsinki (FI)

Correspondence Address: Hollingsworth & Funk, LLC;Suite 125, 8009 34th Avenue South, Minneapolis, MN, 55425, US

(21) Appl. No.: 11/170,723

(22) Filed: Jun. 29, 2005

(51) Int. Cl. H04L 12/66

(52) U.S. Cl. 370/352

(57) ABSTRACT

A computer-implemented method of joining an exclusive network communications group of data communications device users. A network location usable for requesting admission to the network communications group is advertised. A request message is sent from an invitee's communication device to the network location to request joining the network communications group. The invitee's communication device receives an acceptance message from at least one member of the group in response to the request message. The invitee's communication device receives a group application capable of executing via the invitee's communication device in response to the acceptance message. The network communications group is joined via the group application executing on the invitee's communication device.

### FIELD OF THE INVENTION

This invention relates in general to communications networks, and more particularly to handling communications group membership between network-coupled mobile devices.

### BACKGROUND OF THE INVENTION

Mobile communications devices such as cell phones are becoming nearly ubiquitous. The popularity of these devices is due their portability as well as the advanced features being added to such devices. Modern cell phones and related devices offer an ever-growing list of digital capabilities. The portability of these devices makes them ideal for all manner of personal and professional communications.

For example, many phones may be equipped with the ability to send and receive digital text messages. The earliest form of this capability was Short Message Service (SMS), which allowed short text messages to be sent between terminal devices. The increasing availability of Internet-capable mobile devices has allowed a broader range of messaging communications to be practiced on such devices. These communications include Internet email and instant messaging. Similarly, the increased bandwidth available on the mobile networks have allowed more advanced mobile-specific messages to be communicated between mobile devices, such as via Multimedia Messaging Service (MMS).

One unique use of mobile messaging tools is for facilitating group communications. Generally, group communications applications provide a common medium of communication for any type of groups. These groups may be formed based on any type of community relationships, including social, professional, hobbyist/enthusiast, religious, geographical, political, etc.

Communications applications allow group members to exchange data related to the particular purpose of the group. For example, a group dedicated to fishing can communicate current fishing conditions at various locations, and link with other types of data of interest to fishermen, such as weather conditions or government fishing regulations. Data transferred among group members may include text, graphics, streaming media, and the like.

Although the usefulness of group applications may be evident, it is sometimes difficult to organize groups. First, it is desirable keep the group management interfaces simple to encourage use. At the same time it may also be desirable to keep membership exclusive by only allowing in new members who are invited by existing members. Such invitations for membership should be secure so as to prevent intrusions by the uninvited. However, the security mechanisms should be easy to use and their operation should be invisible to the members and invitees.

Another problem in organizing groups is that specialized applications may be required on the user devices in order to interact with the group. Although technically savvy users may be able to discover, download, and install specialized applications, these tasks may be difficult for others. Group membership should be based on shared interests, not in technical ability. Therefore, the provision of new or customized applications to member devices should be performed easily with a minimum of user intervention required.

### SUMMARY OF THE INVENTION

The present disclosure relates to joining an exclusive network communications group of data communications device users. In accordance with one embodiment of the invention, a computer-implemented method of joining an exclusive network communications group involves advertising a network location usable for requesting admission to the network communications group. A request message is sent from an invitee's communication device to the network location to request joining the network communications group. An acceptance is received at the invitee's communication device message from at least one member of the group in response to the request message. In response to the acceptance message, a group application capable of executing via the invitee's communication device is received at the invitee's communication device. The network communications group is joined via the group application executing on the invitee's communication device.

In more particular embodiments, advertising the network location involves advertising a Session Initiation Protocol (SIP) Uniform Resource Identifier (URI). The SIP URI may be registered with a SIP registrar so that the SIP URI directs the request message to a communication device of the at least one member. In one configuration, a binding is created between the SIP URI and an application running on the communication device of the at least one member. The application is compatible with the group application received at the invitee's communication device. In another configuration, the method further involves sending to the invitee's communication device the acceptance message via the application running on the communication device of the at least one member. In one arrangement, a security token is added to the SIP URI to identify legitimate invitation requests.

In other, more particular embodiments, advertising the network location involves advertising the network location using a printed barcode. Advertising the network location may also involve advertising the network location using a near-field communications technology. The near-field communications technology may include radio-frequency ID tag.

In another embodiment of the invention, a data-processing arrangement includes a network interface capable of communicating via a network path. The arrangement includes a user interface capable of interfacing with a user of the data processing arrangement, and a processor is coupled to the network interface and the user interface. A memory is coupled to the processor. The memory has a group communication application that allows the user to communicate with an exclusive network communications group of data communications device users. The group communications application causes the processor to receive via the network interface a request message sent from an invitee's communication device to request joining the network communications group. The processor forms an acceptance message based on acceptance of the request message by the user and sends to the invitee's communication device the acceptance message in response to the request message. The processor also facilitates sending to the invitee's communication device a compatible group application capable of executing via the invitee's communication device in response to the acceptance message. The compatible group application allows the invitee's communication device to communicate with the network communications group.

In a more particular embodiment, the data-processing arrangement includes an advertising media. The group communications application further causes the processor to advertise a network location usable for requesting admission to the network communications group via the advertising media. The advertising media main include a near-field communications device and/or a bar code.

In another more particular embodiment, the group communications application includes at least one group application causing the processor to interact with the user via the user interface to communicate with the users of the network communications group. The group communication application also contains a group middleware component causing the processor to manage communications with the invitee's communication device for purpose of allowing a user of the invitee's communication device to join the network communications group. In one configuration of the data processing arrangement the request message includes a security token, and the data processing arrangement further includes an authentication module that causes the processor to analyze the security token to identify legitimate invitation requests.

In another embodiment of the present invention, a processor-readable medium has instructions executable by a data processing arrangement capable of being coupled to a network for communicating with an exclusive group of data communications device users. The instructions are executable by the data processing arrangement for performing steps that include receiving via the network a request message sent from an invitee's communication device to request joining the network communications group; forming an acceptance message based on acceptance of the request message by the user; sending the acceptance message to the invitee's communication device via the network in response to the request message; and facilitate sending to the invitee's communication device a compatible group application capable of executing via the invitee's communication device in response to the acceptance message, the compatible group application allowing the invitee's communication device to communicate with the network communications group.

In another embodiment of the present invention, a system includes means for advertising a network location usable for requesting admission to an exclusive network communications group of communication device users; means for sending a request message to the network location to request joining the network group; means for receiving at an invitee's communication device an acceptance message from at least one member of the group in response to the request message; means for receiving at the invitee's communication device in response to the acceptance message a group application capable of executing via the invitee's communication device; and means for joining the network communications group via the group application executing on the invitee's communication device.

In another embodiment of the present invention, a computer-implemented method of joining an exclusive network communications group of data communications device users involves generating a single-use authentication token for use in joining the network communications group. An invitation message is sent to an invitee's communication device. The message includes the single-use authentication token and a network location usable for joining the network group. A request message is sent to the network location from the invitee's communication device. The request message contains the single-use authentication token. The single-use authentication token in the request message received at the network location is confirmed. In response to the confirmation, the invitee's communication device is facilitated in joining the network communications group via a group application executing on the invitee's communication device.

In more particular embodiments, the single-use authentication token is associated with the advertised network location. In one arrangement, after sending the invitation message to the invitee's communication device, the association of the single-use authentication token with the advertised network location is removed. Then, a new single-use authentication token for use in joining the network communications group is generated and the new single-use authentication token is associated with the advertised network location.

In another embodiment of the present invention, a data-processing arrangement includes a network interface capable of communicating via a network. A processor is coupled to the network interface and a memory is coupled to the processor. The memory has a group communication application that allows the user to communicate with an exclusive network communications group of data communications device users. The group communications application causes the processor to generate a single-use authentication token for use in joining the network communications group and send an invitation message to an invitee's communication device. The message includes the single-use authentication token and a network location usable for joining the network group. The processor receives a request message from the invitee's communication device via the network. The request message containing the single-use authentication token. The processor confirms the single-use authentication token contained in the request message. In response to confirming the single-use authentication token, the processor facilitates the invitee's communication device in joining the network communications group via a group application executing on the invitee's communication device.

In more particular embodiments, the data-processing arrangement of includes an advertising media. The group communications application causes the processor to send the invitation message to the invitee's communication device via the advertising media. The advertising media may include a near-field communications device and/or a bar code. The group communications application may be further arranged to causes the processor to associate the single-use authentication token with the advertised network location. After sending the invitation message to the invitee's communication device, the processor removes the association of the single-use authentication token with the advertised network location, generates a new single-use authentication token for use in joining the network communications group, and associates the new single-use authentication token with the advertised network location.

In another embodiment of the present invention, a processor-readable medium has instructions that are executable by a data processing arrangement capable of being coupled to a network for communicating with an exclusive group of data communications device users. The instructions are executable by the data processing arrangement for performing steps that include generating a single-use authentication token for use in joining the network communications group. An invitation message is sent to an invitee's communication device. The message includes the single-use authentication token and a network location usable for joining the network group. A request message is received from the invitee's communication device via the network. The request message contains the single-use authentication token. The single-use authentication token contained in the request message is confirmed. In response to confirming the single-use authentication token, the processor facilitates the invitee's communication device in joining the network communications group via a group application executing on the invitee's communication device.

In another embodiment of the present invention, a system includes: means for generating a single-use authentication token for use in joining to an exclusive network communications group of communication device users; means for sending to an invitee's communication device an invitation message including the single-use authentication token and a network location usable for joining the network group; means for sending a request message to the network location from the invitee's communication device, the request message containing the single-use authentication token; means for confirming the single-use authentication token in the request message received at the network location; and means for facilitating the invitee's communication device in joining the network communications group via a group application executing on the invitee's communication device in response to confirming the single-use authentication token.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating invitation to a network communications group according to embodiments of the present invention;

FIG. 2 is a block diagram illustrating a components of a network communications group according to embodiments of the present invention;

FIG. 3 is a sequence diagram illustrating providing a group application used by an invitee to communicate with a network communications group according to embodiments of the present invention;

FIG. 4 is a sequence diagram illustrating authentication of an invitee to a network communications group according to embodiments of the present invention;

FIG. 5 is a block diagram of a mobile data processing arrangement according to embodiments of the present invention;

FIG. 6 is a flowchart that illustrates providing of an application to the device of a newly added group member according to embodiments of the present invention; and

FIG. 7 is a flowchart that illustrates authentication of invitees to the group according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to allowing mobile device users to set-up, join, and manage communications groups. These groups typically include people who participate in the groups via mobile communications devices (e.g., cell phones) although other entities may also participate in the groups, including wired computer users or automated machines that are not associated with a particular person (e.g., a server). The groups may be formed for any purpose, although one particular use anticipated for the present embodiments is to support interaction between members of social groups.

Social groups are common in human interaction. Networked applications for both personal computers and mobile devices have been envisioned to facilitate communication inside social groups. One aspect of the present invention relates to the problem of establishing communications inside such a social group. It may be assumed that a networked software application is used to communicate between people in a group. Such an application needs to recognize who belongs to the group. For example, this information may be given to the application in the form of a list of members' addresses, or a list of their phone numbers. After the application is configured with the list of group members, it can subsequently enable the members to communicate with each other.

Generally, the value of a group is the ability to control membership. Such groups may have mechanisms to keep the groups exclusive, i.e., to accept or solicit only a restricted patronage. New members may be added to the list of exclusive members, but new members should only be brought in by existing members of the group. When a networked application needs to be configured with the list of group members, the complete list is often not known beforehand. In these cases, it is assumed that people can join the group later. The problem is, how do new users discover that a group exists and how do they request to be joined in the group?

The group membership list and definition usually may exist anywhere on the network, such as a network server computer or on client devices (e.g., in a peer-to-peer application). For purposes of discussion, it will be assumed that the group list resides on a mobile device capable of communicating using Session Initiation Protocol (SIP) for peer-to-peer communication. However, those skilled in the art will recognize that many of the concepts described herein are applicable to other protocols and network relationships (e.g., client-server).

People can use many ways to discover that a group exists. For example, they might read an advertisement on the Internet or their friends could tell them about the group. After discovering that a group exists, the person must contact the group in an attempt to become a member. The present invention provides ways for a person to request to be joined in a group. It assumes that the candidate member has already discovered the group's existence and identification using some other means.

In many arrangements, the candidate member can join the group by contacting the administrator of the group. The group administrator has control of the member list and can add new members and remove unwanted ones. Joining a group, however, is not necessarily the same with every group; different groups may have different policies on how to accept new members. It is therefore not immediately evident how to join a group even if its existence is known.

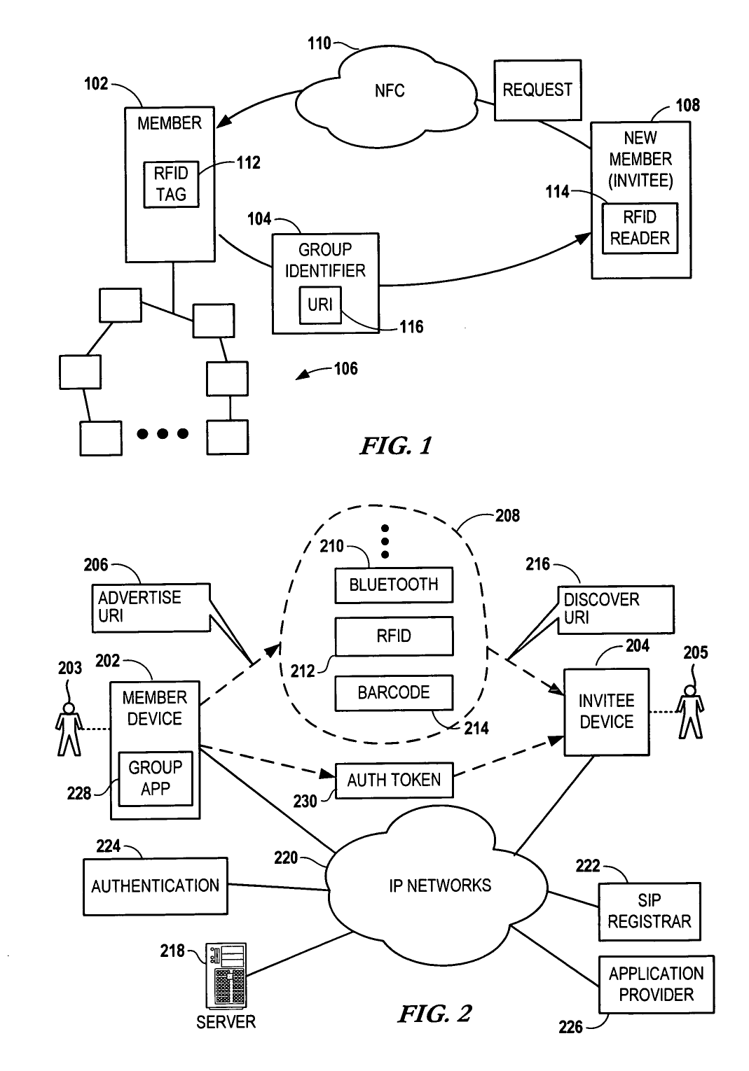

In reference now to FIG. 1, a diagram illustrates group membership according to embodiments of the present invention. A device 102 of a group member can advertise a communication group 106 by transmitting or otherwise publicizing a group locator or an identifier 104. The person (i.e., the invitee device 108) who gets the identifier 104 uses that for contacting the group 106 (or a group member device 102) in order to join the group 106. In order to protect the integrity or privacy of the group 106, it may be important that the user of invitee device 108 is the same person to who received the identifier 104 in the first place. A stranger or intruder, who happened to obtain the identifier 104, should not be given access to join the group 106.

In one example, the group identifier 104 can be discovered and identified using a Near-Field Communications (NFC) technology 110. An example of NFC technology 110 is Radio Frequency Identification (RFID). RFID systems may include a wide range of both passive and active NFC devices, including passive or active RFID tags (e.g., RFID tag 112). Passive RFID tags do not require a power supply. Power is provided to a passive RFID tag by small electrical currents induced in the device's antenna by incoming radio frequency scans. Because passive RFID tags must rely on minute amounts of power, they can only communicate limited information, typically just an ID number. Active RFID tags have an independent power source. As such, active tags may have longer ranges and may engage in more sophisticated communications with other devices.

In one embodiment of the present invention, the group identifier 104 includes a Uniform Resource Identifier (URI) 116. The URI 116 may be a text string containing a name or address that can be used to access network resources. The URI 116 can be made either publicly or privately available to others using the RFID tag 112. The URI 116 can be detected by using standard RFID technologies known in the art, such an RFID reader 114 included in the invitee's mobile device 108.

The group member that wishes to invite another member has a URI 116 programmed into an RFID tag 112 that may be integrated with the user's mobile device 102. Alternatively, the RFID tag 112 may be a small object carried on one's person, such as on a keychain. The invited person reads the tag using an RFID reader 114 that may be integrated into that user's mobile device 108. The mobile device 108 can be enabled to join the group based on the URI 116 (or any other information) read from the RFID tag 112.

In reference now to FIG. 2, a diagram shows a more detailed example of a group membership arrangement according to embodiments of the present invention. As in FIG. 1, a device 202 is owned by a group member 203. The member device 202 is used to allow an invitee 205 to join a group via a device 204 owned by the invitee 205. An advertised URI 206 is made available by the member device 202 via an NFC technology 208. This example shows three examples of NFC technologies 208: Bluetooth 210, RFID tag 212, and a barcode 214. Bluetooth 210 is a wireless communication standard that allows electronic devices to communicate over ad-hoc, short-range wireless links. The barcode 214 may be any machine-readable visual tag.

In the illustrated example, the invitee device 204 discovers a URI 216 such as by one or more of the NFC technologies 208. The URI 216 may be used to access resources available across any private or public network, such as the Internet Protocol networks 220 shown. The discovered URI 216 may access any network element involved in membership transactions, including the member device 202 and/or a server 218. For example, the URI 216 may reference a SIP registrar service 222 that may run on any device on the network 220, including the member device 202 and/or server 218.

In one arrangement, the URI 216 may be discovered publicly, but the invitee device 204 will still require an authentication token in order to join the group. These authentication tokens may be created and managed by an authentication service 224 that may run on any device on the network 220, including the member device 202 and/or server 218. The tokens may be provided to the invitee device 204 in order to validate the invitee's identity. Implementations of the authentication server 224 are described in greater detail elsewhere below.

It will be appreciated that the example illustrated in FIG. 2, the existing member device 202 and the invitee device 204 presumably have compatible applications installed that allow the devices 202, 204 to participate in the group. A locally installed group application on the invitee device 204 would decode the discovered URI 216 and use the URI (and possibly an authentication token) to start a well-known protocol in order to join the group. However, if there was no compatible application locally installed on the invitee device 204, or if the protocol were not well known, then URI and authentication token would do the invitee 205 no good.

Some group communications applications will not be pre-installed on the invitee device 204. In order to join in the group, the invitee 205 would have to obtain a third item besides the URI and authentication token, namely the group communications application. Therefore, an application provider service 226 may be required in order for the invitee device 204 to join the group. The application provider service 226 may be hosted on any device on the network 220, including the member device 202 and/or server 218.

The download of the communication application to the invitee device 204 from the application provider service 226 can be integrated into membership joining procedures. In this way, the invitee 205 can seamlessly join in the group without having to search for and install a particular application. As an example of this, assume the member 203 is part a baseball club. The member 203 has the club application 228 installed on his or her device 202. The member 203 chooses to advertise the club to solicit new members. The application 228 sets up the advertisement and outputs a semacode (e.g., a visual tag in the form of a barcode 214) to a local printer. The member 203 then posts the barcode 214 on a public bulletin board at a local gym, hoping that people will notice it and possibly join the club.

The invitee 205 happens to see the advertisement for the baseball club in the gym, and would like to join the club. The advertisement tells the invitee 205 to read the URI 216 from semacode 214 and send a message to join. The invitee 205 uses the device 204 (e.g., a camera equipped cellular phone) to read the semacode 214 imprinted on the advertisement and decode the club information. However, the invitee device 204 does not have the necessary club application installed, so the device 204 is only able to read the URI 216 that was embedded in the semacode 214. The URI 216 is a SIP URI, so the invitee device 204 offers the invitee 205 an option to either place a call to that URI or send an instant message.

The invitee 205 may choose to send an instant message, since that is what the advertisement suggested. After sending, the invitee 205 gets a message back on his/or her device 204 saying that your request has been processed. Shortly after that, the invitee 205 receives a prompt to download and install the club application 228. The invitee 205 then receives an invitation to join the club via the newly installed application 228. The club application 228 allows the invitee 205 to browse all the necessary information about the club before finally accepting the invitation to join.

The functionality described above in relation to FIG. 2 may require that a SIP client (e.g., the member device 202) be allowed to register new, custom URIs at the SIP registrar 222. This is to allow for cases where the registrar operator has default policies in place that prevent this type of URI registration. A special binding is then created from a registered SIP URI to an application (e.g., the group application 228) so that all incoming SIP requests to that URI will be dispatched to that application. Any available SIP-based applications used in the transactions (e.g., a SIP application running on the invitee device 204) should also be configured to contact a SIP URI that was discovered via the advertisement.

Generally, the URI 206 advertised by the member 203 will be publicly accessible if special options such as encryption or authentication are not used. When a public URI is used as a group contact, it is not desirable that anyone who happens to obtain the URI is able to contact or join the group. This is because many groups prefer that only existing members be able to invite others to join, just like in real life. For example, a member of a hockey team asks his friend to join his club, (i.e., group) and provides him with the required information to perform this transaction (i.e., joining the group).

One way of ensuring that invitations to a communications group remain private is to advertise the group URI publicly 206, and privately share with invitee 205 the authentication keys used to join at the URI. In such a scenario, the invitee 205 must type in the password and other authentication data into the device 204 when prompted. This can be cumbersome and error-prone.

An improved mechanism for joining the group would hide and automate the details of the authentication. If there has already been close contact (e.g., face-to-face meeting) between the existing member 203 and the invitee 205, then the most reliable form of identity authentication has already taken place. Therefore, member 203 can give an authentication token 230 to the invitee 205 at such a meeting. For example, the token 230 can be transferred by touching the invitee's mobile phone 204 with the phone 202 of the existing member to read the RFID data. The invitee 205 then uses the token to join the group using the publicly available URI 216. The URI could be made publicly available using any communication means 216 described hereinabove, including RFID 212.

In one embodiment, the URI 216 may be advertised using a longer-range RFID technology 212, such as an active RFID tag or radio transmitter. The private authentication token 230 could be transmitted using passive RFID, such as an RFID tag that requires close proximity or direct physical contact between devices in order to be activated. Therefore, both the public URI 216 used in group formation and the authentication token 230 can be distributed using RFID 212. Similar public and private distributions may be performed using any combination of NFC technologies 208, and also user other technologies that operate over wider distance. For example, private authentication may also use biometrics, smart cards, magnetic strip cards/readers, portable storage devices (e.g., flash memory drives), etc. Similarly, public distribution of URLs may use radio broadcasts, Web pages, email, public flyers, etc.

Applying this example to the football club use case, assume the current member 203 of the football hobby club has the club application 228 and club data stored in his or her device 202 (e.g., a mobile phone). The football club contact address (e.g., URI 206) can be advertised via an RFID tag integrated to the phone 202. Based on this advertisement (or direct verbal contact) the member 203 asks the invitee 205 to join the club. If the invitee 205 wants to join the club, the member 203 and invitee 205 make their mobile phones 202, 204 (or similar computing devices) touch and the procedure of joining the group is initiated.

There may be at least two ways of preventing unwanted contacts in the above-described scenario. The first way involves creating a randomly named URI that is not easy to guess. This requires that the contact URI 206 be recreated each time it is advertised. The re-creation of the URI 206 requires also it to be registered to a registrar (e.g., the SIP registrar 222) each time it is changed. In an alternate implementation, a static URI 206 is used, and a randomly created authentication token 230 (nonce) is attached to the request. The token 230 changes each time the URI 206 is read by the invitee 205.

In this latter implementation, the token 230 is used to authenticate the invitee 205 when he/she tries to contact the device 202 of the group member 203 (or other network element) in order to join. Thus, the URI 206 does not have to be secret, and can reference a published group URI (or the user's own contact URI; e.g. SIP URI). It is sufficient that the nonce 230 given to the other user 205 is unique and random. This ensures that the contacting invitee 205 is really the person who fetched the URI 216 from the member's phone 202.

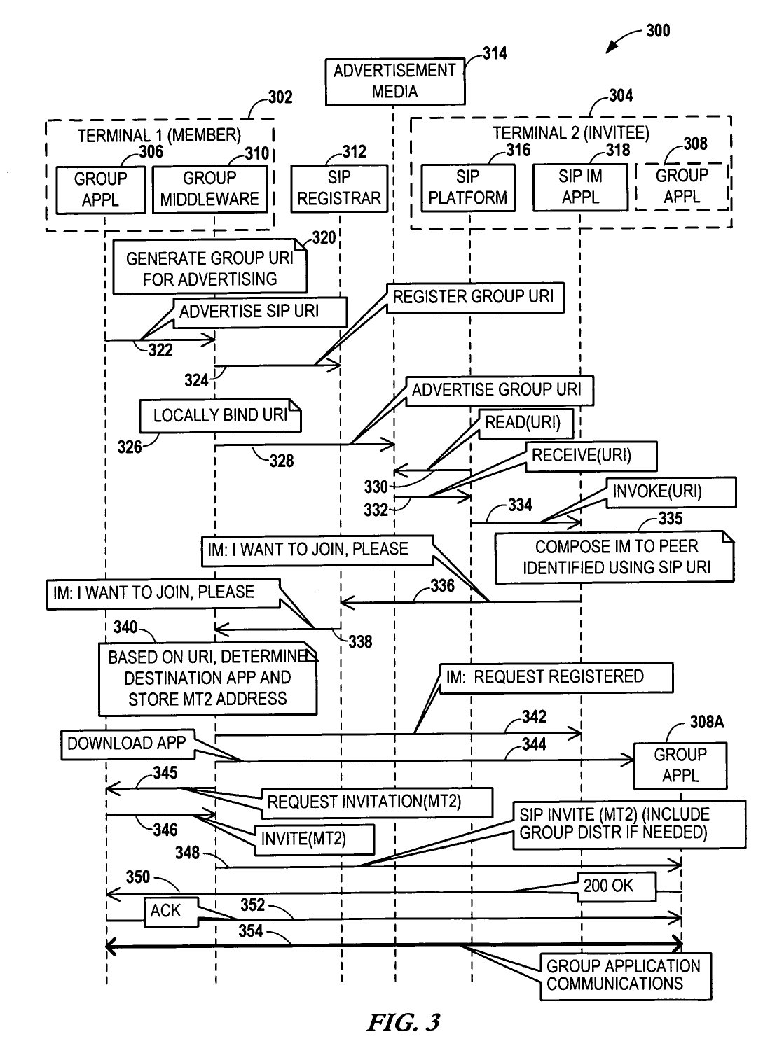

In reference now to FIG. 3, a sequence diagram 300 illustrates aspects of providing a group application as part of the group joining process according to embodiments of the present invention. The illustrated procedure allows a candidate member (i.e., invitee) to join the group without having to have the actual group application installed. The candidate can simply call or send a message to the SIP URI that was being advertised. That action is considered a request to be invited to the group, and it will be forwarded to the group application in a member's device. The group application will then invite the candidate member to the group.

The communications in the diagram 300 occur between a first terminal device 302 and a second terminal device 304. The first terminal 302 belongs to an existing member of a group (inviter) and the second terminal 304 belongs to the invitee. The first terminal 302 contains a group application 306. The group application 306 is a software application that provides group communication services such as shared discussion boards and image libraries for a group of users. The group application 306 may provide group communication services like chat, shared calendar/pictures/files etc. The group application 306 may also be used to manage the membership registrars, including the functionality needed to advertise the group to outside parties.

The second terminal 304 may also have a compatible application installed, as indicated by the application 308. However, in the present example, it will be assumed that the second terminal 304 is capable of running the application 308, but does not yet have it installed.

The first terminal 302 also contains (or otherwise has access to) group middleware 310. Group middleware 310 is typically a software library that provides the SIP and group advertisement implementations to the group application 306. The middleware can also provide group management features. The middleware 310 provides logical connectivity between all peers (i.e., the group) that use the group application 306. The middleware 310 typically uses an IP packet network for application protocols and NFC (as represented by advertising media 314) for sharing contact information and keys. Middleware 310 may also be used to manage group memberships and to carry out group management operations like inviting new members, joining to a group, etc.

The terminals 302, 304 are typically SIP-enabled, and as such can communicate with a SIP registrar 312. The SIP registrar 312 is a standard SIP entity that takes care of the endpoints' registered addresses. Endpoints (such as the terminal 302) can register their addresses at the SIP registrar 312, via a REGISTER request. The SIP registrar 312 places the information it receives via the REGISTER requests into the location service for the domain handled by the registrar 312.

The first terminal 302 needs a way to transmit a group URI to other people, and this is done via the advertisement media 314. For example, the advertisement media might take the form of RFID tags, printed semacodes, web pages, etc. The URI could also be published on a Web site or using any other form of Web-based communications, including email, XML newsfeeds (e.g., RSS), peer-to-peer file sharing, instant messaging, etc.

The second terminal 304 is presumed to be a SIP-enabled terminal, and as such has its own SIP platform 316. The SIP platform 316 contains generic SIP support features that are assumed to be present on any SIP-enabled mobile device. The second terminal 304 also includes other applications, including in this example a SIP Instant Messaging (IM) application 318. The SIP IM application 318 may be assumed to be present in any SIP-enabled mobile device. Other applications may be used for the purposes described herein in relation to the SIP IM application 318, such as a VoIP call mechanism.

The illustrated sequence begins when the existing member of the group uses the first terminal 302 to create a group (320) and instructs the group middleware 310 to advertise (322) the group's URI to outside parties. The group middleware 310 advertises the URI by first registering (324) a new URI with the SIP registrar 312. The new URI points to the member's mobile device 302. The terminal 302 also binds (326) the URI locally to point to the group middleware 310. This binding (326) defines that any SIP requests received through this URI will be dispatched to the group application 306 that made the registration. In this aspect, the binding (326) is similar behavior to handling e-mail messages from a mailing list. An e-mail client can be configured to automatically organize incoming messages to respective folders based on the ‘To’ e-mail field. In this implementation, the binding (326) results in the registered URI being used to direct incoming SIP requests to respective client applications.

After the URI is registered (324) and locally bound (326), the URI can be advertised (328). In this example, the advertising (328) involves embedding or otherwise placing the URI into an advertisement medium 314, such as an RFID tag on the member's terminal 302 or a printed semacode on a public, physical bulletin board. A candidate member can discover the advertised URI by reading (330, 332) the advertisement. The advertisement implies that the user can request to join the group by contacting the URI.

When the candidate member reads (330, 332) the advertisement URI, the SIP platform 318 on his device 304 may detect from the URI which application to invoke (334). If the platform is unable to find a matching application, it lets the user choose (not shown) an application to invoke (334) from a list of SIP-enabled applications. Commonly, SIP-enabled devices have at least Voice over IP (VoIP) call and IM capabilities. In this case, the user chooses to invoke (334) an instant messaging application. Using the IM application, the user composes (335) and sends an instant message 336 to the received URI.

The message 336 sent by the IM application may include user-composed data, such as, “I want to join please”. This message 336 is considered a request to be invited to the group. The actual content of the message 336 may vary depending on the particular implementation. One purpose of the message 336 is to transmit the SIP address of the candidate member to the member who advertises the group. The SIP registrar 312 receives the request 336 and forwards (338) the request to the terminal 302.

The group middleware 310 receives the forwarded request (338) through the bindings established before. The group middleware 310 determines (340) the associated group and stores the sender address. Depending on whether the candidate member made a call or sent a message, the group middleware 310 can either play back a voice clip to the caller (“Your request has been received and will be processed, thank you for calling, you can hang up now”) or send as a response an instant message to signal that the request has been received and processed. In the illustrated example, the middleware 310 responds to the candidate by sending an instant message 342 to candidate's terminal 304.

At this time, the terminal 304 may also download (344) the application 308A, which can be installed onto the terminal 304. This download (344) may be initiated by the invitee, such as by the presentation of a link to an application server in the response message 342. Alternatively, the application 308A may be “pushed” to the terminal 304 using a mechanism such as Wireless Application Protocol (WAP) Push. After the application 308A is downloaded (344), it may be manually or automatically installed in the terminal 304.

After responding (342) to the candidate member's request, the group middleware 310 relays (345) the request for invitation to the group application 306 on the first terminal 302. At this point, the group application 306 knows who requested to join the group. The application 306 can now send (346, 348) an invitation to join the group. Because the group application 308A is now available on the candidate's terminal 304, both applications 306, 308A can communicate the group invitation 348 to the candidate member and set up the session (350, 352, 354) in the appropriate manner.

Although downloading (344) of the application 308A is shown to occur after the user request has been confirmed (e.g., after the instant message 342), the downloading (344) may also occur later. For example, the process of downloading (344) and installing the group application could be performed during the invitation process (348). This is what is indicated by the “include group distr if needed” entry in the invitation request 348. In such a case, the application (308A) would not be downloaded if the owner of the invitee terminal 304 declines the invitation.

The implementation shown in FIG. 3 has many advantages. The candidate member's device 304 does not need to find out exactly which application to use to handle the URI. In addition, the group application 308 is not required for initially reading or handling the advertisement. The group application 308,308A can be distributed as needed, using mechanisms known in the art. Alternative implementations of the example of FIG. 3 are also possible. For example, the URI that was advertised (328) may contain parameters that instruct the candidate member's device 304 to use some specific mechanism to contact the URI. For example, using a URI such as
“sip: lionsclub@host.com?subj=Request;content=38322df24ae8”

This example URI might instruct the device to compose an instant message with the given subject and content. The content could include, for example, a security token to identify legitimate invitation requests.

In other implementations, the group advertisement URI does not have to point to the inviting member's device 302. For example, the URI may point to a group service entity in the fixed network that handles the group management altogether. In such a case, registering (324) a separate URI for group advertisement is not necessary, and also the local binding (326) does not need to take place. However, there should be some manner of server-based policy for accepting new users to the group. For example, the group applications 306, 308 could be enabled to communicate with the server in order to set these policies.

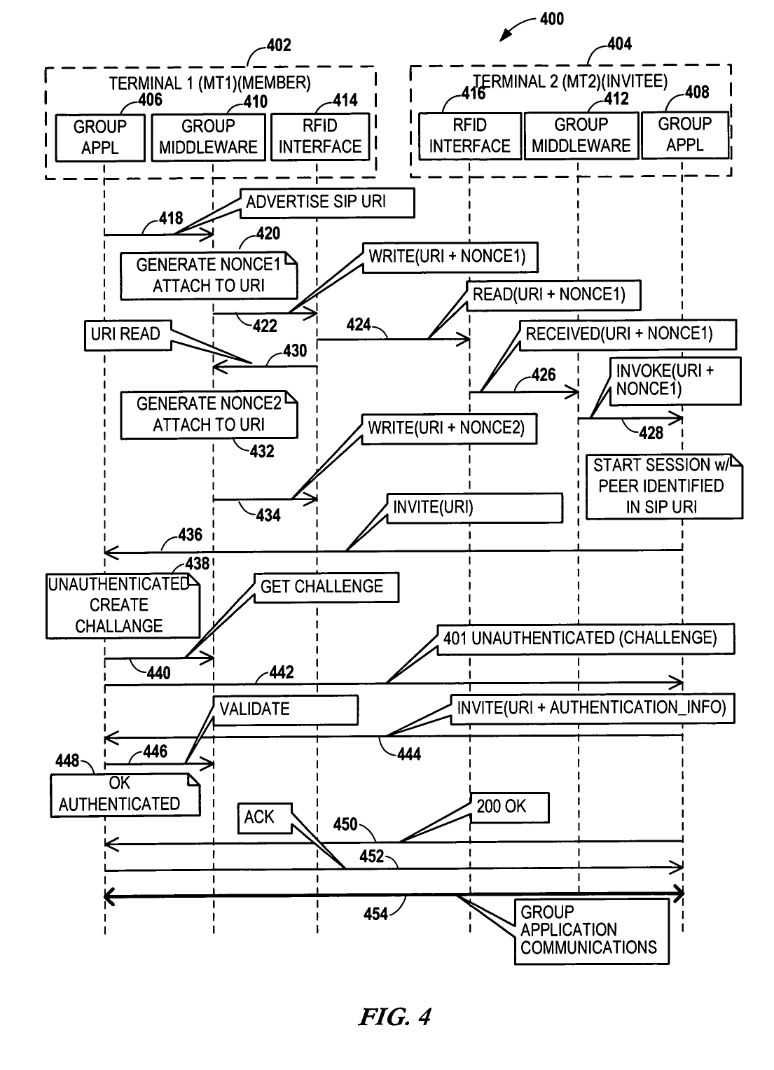

In reference now to FIG. 4, a sequence diagram 400 illustrates aspects of authenticating members who are invited to join a group according to embodiments of the present invention. The illustrated procedure provides automatic authentication of invitees that are invited into the group by an existing member. The procedure provides an easy, natural and intuitive way to advertise and join a group communication application without the user(s) having to type or remember passwords.

The diagram 400 shows an example method of implementing transitive trust between a member and invitee who already trust each other (e.g., have already met). The member and invitee have respective terminal devices 402, 404 that are capable of network communications. The terminals 402, 404 have respective group applications 406, 408, group middleware 410, 412, and advertising media, here represented as RFID interfaces 414, 416. The invitee's terminal 404 may already have the group application 408 installed, as indicated here, or the application 408 may be downloaded as part of the group joining process, as described in relation to FIG. 3.

The member terminal 402 creates a group and instructs the group middleware 410 to advertise (418) the group's URI through the RFID interface 414 (e.g., an RFID tag). The group middleware adds (420) an authentication parameter (nonce1) to the URI and writes (422) the URI+nonce1 to the RFID interface 414. The middleware 420 also stores the nonce locally for later verification (not shown). The nonce is typically a single-use authentication token. Therefore, the nonce can be used by a single invitee for a single group-joining transaction. The invitee's terminal 404 reads (424, 426) the URI+nonce1 from the RFID tag and invokes (428) the group application 408 with this information. When the group middleware 410 on the member's terminal 402 notices (430) that the URI is read, it creates (432) a new nonce, nonce2, and writes (434) the URI+nonce2 to the RFID interface 414. The next user that touches the member's device 402 will read this newly created nonce.

The invitee's group application 408 starts the joining procedure by contacting (436) the member's terminal 402 using the SIP protocol (e.g., INVITE). The member's terminal 402 responds (438, 440, 442) with a challenge message (e.g., “401 Unauthenticated”). The invitee's terminal 404 calculates authentication information using the challenge and nonce1. The authentication info is the attached to a new INVITE that is sent (444) to the member's terminal 402.

The member's terminal 402 validates (446, 448) that the other terminal 404 is authenticated. For example, the group application 406 can iterate through a local set of stored nonces in order to verifying the authentication information. The member's terminal 402 responds (450) with “200 OK,” and the invitee's terminal 404 acknowledges (452) the session. At this point, the group joining procedure is finalized with an application specific protocol being instantiated (454) between two group application peers 406, 408.

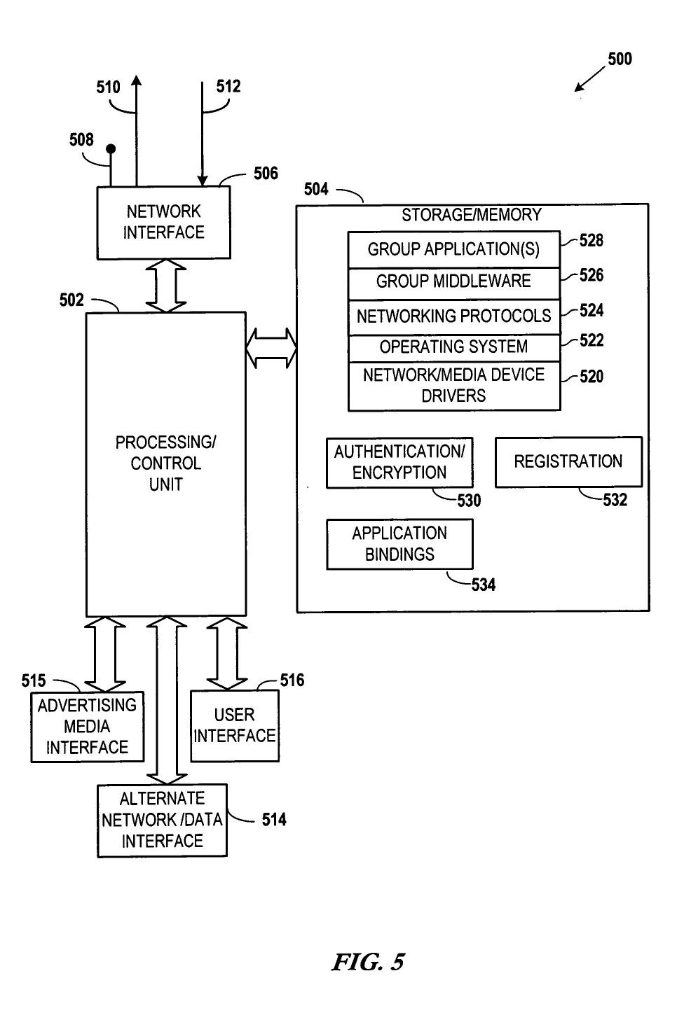

The terminals 402, 404 used to effect group communications may be any computing devices known in the art. In particular, mobile devices are useful in the role of group data communications. In FIG. 5, a mobile computing arrangement 500 is illustrated that is capable of group communications according to embodiments of the present invention. Those skilled in the art will appreciate that the exemplary mobile computing arrangement 500 is merely representative of general functions that may be associated with such mobile devices, and also that landline computing systems similarly include computing circuitry to perform such operations.

The illustrated mobile computing arrangement 500 may be suitable for processing data connections via one or more network data paths. The mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The program storage/memory 504 may also include operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes a network interface 506 suitable for performing wireless data exchanges via a network.

The network interface 506 may include a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. The network interface 506 may also include transceiver, generally coupled to an antenna 508, that transmits the outgoing radio signals 510 and receives the incoming radio signals 512 associated with the wireless device 500.

The mobile computing arrangement 500 may also include an alternate network/data interface 514 coupled to the processing/control unit 502. The alternate interface 514 may include the ability to communicate on proximity networks via wired and/or wireless data transmission mediums. The alternate interface 514 may include the ability to communicate using Bluetooth, 802.11 Wi-Fi, Ethernet, IRDA, USB, Firewire, and related networking and data transfer technologies. The processor 502 may also be coupled to an advertising media interface 515. The advertising media interface 515 may be included as part of the network interfaces 506, 514, or may be an entirely separate device and media. For example the advertising media interface 515 may include an RFID tag and/or reader.

The mobile computing arrangement 500 is designed for user interaction, and as such typically includes user-interface 516 elements coupled to the processing/control unit 502. The user-interface 516 may include, for example, a display such as a liquid crystal display, a keypad, speaker, microphone, etc. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The storage/memory 504 of the mobile computing arrangement 500 may include software modules for joining communication groups via any of the network interfaces (e.g., main and alternate interfaces 506, 514). In particular, the storage/memory 504 includes device drivers 520. The device drivers 520 may provide low-level hardware access to the network interfaces 506, 514, the advertising media interface 515, and the user interface 516.

Above the device drivers 520 are typically accessed via an operating system 522. The operating system 522 may include both a kernel for low level device and job control, as well as higher level services and Application Program Interfaces (APIs). A set of networking protocols 524 may be included as part of the operating system 522, or may be included as add-in modules/drivers, system services or applications. For example, the networking protocols 524 may contain a SIP platform layer for handling services associated with SIP.

The mobile computing arrangement 500 may also include a group middleware component 526. This group middleware 526 can provide common group services that may be associated with multiple group applications 528. Generally, the group applications 528 are group specific applications that are tailored to the end uses envisioned by the group's creators. The group applications 528 can establish communication groups using any medium and method of inter-group communication now known or later developed. Examples of communications that may be used as part of a communication group include text/instant messaging, email, Web services, voice communications, news feeds, streaming media, etc. The concepts described herein are applicable regardless as to how the communication groups are implemented and what mediums and means are used to effect communications in the group.

The group applications 528 may deal with different types of media, different user interfaces, different underlying protocols, and have many other aspects that are particular to the end use. The group middleware 526 can provide a consistent interface between all of the applications 528 and the lower level layers such as the networking protocols 524, the operating system 522, and the drivers 520. In this way, the group middleware 526 can help ensure that certain tasks common to all group activities (e.g., the joining of new members) are handled consistently, no matter what end application 528 is ultimately used.

The storage/memory 504 may also include other functional modules that may be accessed by multiple levels of software and services running on the mobile computing arrangement 500. For example, an authentication module 530 may be used by components such as the network protocols 524, group middleware 526, and group applications 528 for such common tasks as generating/verifying authentication tokens, encrypting data, establishing secure connections, etc. Similarly, a registration module 532 may work with other components in registering URIs with network entities such as SIP registrars. An application binding module 534 may work amongst various layers of the system software in order to deliver incoming messages and other data to the correct group application 528.

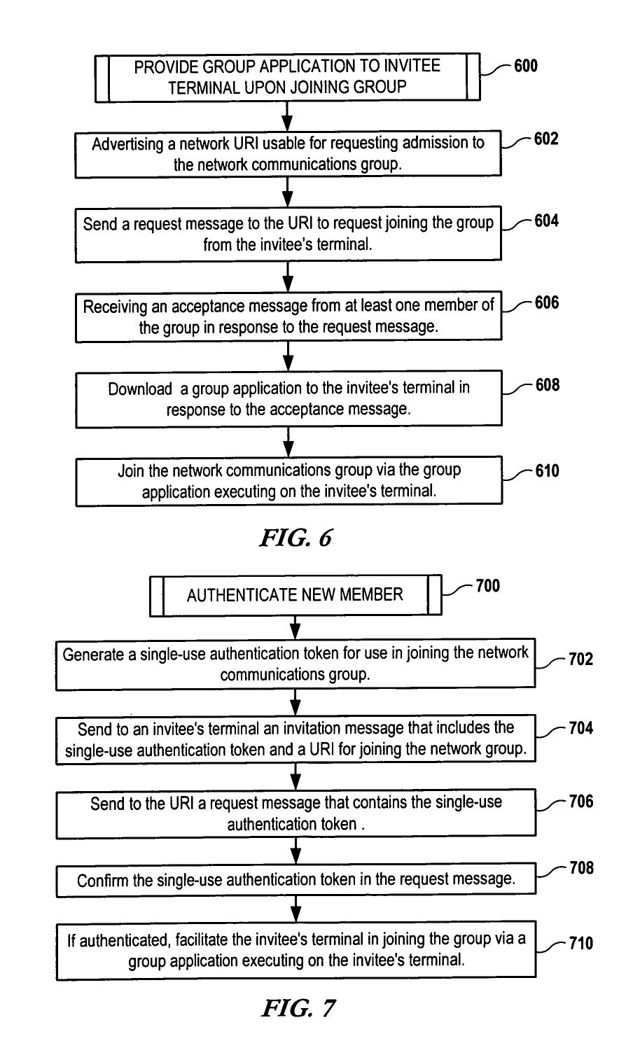

In reference now to FIG. 6, a flowchart illustrates a procedure 600 for providing an application to an invitee terminal according to embodiments of the present invention. A network location (e.g., a URI) is advertised (602). The URI is usable for requesting admission to the network communications group. A request message is sent (604) to the URI from the invitee's terminal. The message is formatted to request joining the network communications group.

The invitee's terminal receives (606) an acceptance message from at least one member of the group in response to the request message. The invitee's communication device also downloads (608) a group application capable of executing via the invitee's communication device in response to the acceptance message. The invitee then joins (610) the network communications group via the group application executing on the invitee's communication device.

Turning now to FIG. 7, a flowchart illustrates a procedure 700 for authentication of invitees to the group according to embodiments of the present invention. A single-use authentication token for use in joining the network communications group is generated (702). An invitation message is sent (704) to the invitee's terminal. The message includes the single-use authentication token and a URI usable for joining the network group.

When the invitee chooses to join, a request message is sent (706) to the network location from the invitee's communication device. The request message contains the single-use authentication token. The single-use authentication token in the request message received at the network location is confirmed (708). If the invitee is authenticated, then the invitee's terminal is facilitated (710) in joining the network communications group via a group application executing on the invitee's terminal.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A computer-implemented method of joining an exclusive network communications group of data communications device users, comprising:
advertising a network location usable for requesting admission to the network communications group;
sending from an invitee's communication device a request message to the network location to request joining the network communications group;
receiving at the invitee's communication device an acceptance message from at least one member of the group in response to the request message;
receiving at the invitee's communication device in response to the acceptance message a group application capable of executing via the invitee's communication device; and
joining the network communications group via the group application executing on the invitee's communication device.

2. The method of claim 1, wherein advertising the network location comprises advertising a Session Initiation Protocol (SIP) Uniform Resource Identifier (URI).

3. The method of claim 2, further comprising registering the SIP URI with a SIP registrar so that the SIP URI directs the request message to a communication device of the at least one member.

4. The method of claim 3, further comprising creating a binding between the SIP URI and an application running on the communication device of the at least one member, the application being compatible with the group application received at the invitee's communication device.

5. The method of claim 4, further comprising sending to the invitee's communication device the acceptance message via the application running on the communication device of the at least one member.

6. The method of claim 2, further comprising adding a security token to the SIP URI to identify legitimate invitation requests.

7. The method of claim 1, wherein advertising the network location comprises advertising the network location using a printed barcode.

8. The method of claim 1, wherein advertising the network location comprises advertising the network location using a near-field communications technology.

9. The method of claim 8, wherein advertising the network location using the near-field communications technology comprises advertising the network location using a radio-frequency ID tag.

10. A data-processing arrangement, comprising:
a network interface capable of communicating via a network path;
a processor coupled to the network interface; and
a memory coupled to the processor, the memory having a group communication application that allows the user to communicate with an exclusive network communications group of data communications device users, the group communications application causing the processor to,
receive via the network interface a request message sent from an invitee's communication device to request joining the network communications group;
form an acceptance message based on acceptance of the request message by the user;
send to the invitee's communication device the acceptance message in response to the request message; and
facilitate sending to the invitee's communication device a compatible group application capable of executing via the invitee's communication device in response to the acceptance message, the compatible group application allowing the invitee's communication device to communicate with the network communications group.

11. The data-processing arrangement of claim 10, further comprising an advertising media, and wherein the group communications application further causes the processor to advertise a network location usable for requesting admission to the network communications group via the advertising media.

12. The data-processing arrangement of claim 11, wherein the advertising media comprises a near-field communications device.

13. The data-processing arrangement of claim 11, wherein the advertising media comprises a bar code.

14. The data-processing arrangement of claim 10, further comprising a user interface capable of interfacing with a user of the data processing arrangement, and wherein the group communication application further comprises:
at least one group application causing the processor to interact with the user via the user interface to communicate with the users of the network communications group; and
a group middleware component causing the processor to manage communications with the invitee's communication device for purpose of allowing a user of the invitee's communication device to join the network communications group.

15. The data processing arrangement of claim 10, wherein the request message comprises a security token, and where the data processing arrangement further comprises an authentication module that causes the processor to analyze the security token to identify legitimate invitation requests.

16. A processor-readable medium having instructions stored thereon which are executable by a data processing arrangement capable of being coupled to a network for communicating with an exclusive network communications group of data communications device users, the instructions executable by the data processing arrangement for performing steps comprising:
receiving via the network a request message sent from an invitee's communication device to request joining the network communications group;
forming an acceptance message based on acceptance of the request message by the user;
sending the acceptance message to the invitee's communication device via the network in response to the request message; and
facilitate sending to the invitee's communication device a compatible group application capable of executing via the invitee's communication device in response to the acceptance message, the compatible group application allowing the invitee's communication device to communicate with the network communications group.

17. A system comprising:
means for advertising a network location usable for requesting admission to an exclusive network communications group of communication device users;
means for sending a request message to the network location to request joining the network group;
means for receiving at an invitee's communication device an acceptance message from at least one member of the group in response to the request message;
means for receiving at the invitee's communication device in response to the acceptance message a group application capable of executing via the invitee's communication device; and
means for joining the network communications group via the group application executing on the invitee's communication device.

18. A computer-implemented method of joining an exclusive network communications group of data communications device users, comprising:
generating a single-use authentication token for use in joining the network communications group;
sending to an invitee's communication device an invitation message including the single-use authentication token and a network location usable for joining the network group;
sending a request message to the network location from the invitee's communication device, the request message containing the single-use authentication token;
confirming the single-use authentication token in the request message received at the network location; and
in response to confirming the single-use authentication token, facilitating the invitee's communication device in joining the network communications group via a group application executing on the invitee's communication device.

19. The method of claim 18, further comprising advertising the network location via an advertising media.

20. The method of claim 19, further comprising associating the single-use authentication token with the advertised network location.

21. The method of claim 20, further comprising, after sending the invitation message to the invitee's communication device:
removing the association of the single-use authentication token with the advertised network location;
generating a new single-use authentication token for use in joining the network communications group; and
associating the new single-use authentication token with the advertised network location.

22. The method of claim 18, further comprising delivering the group application to the invitee's communication device in response to confirming the single-use authentication token.

23. The method of claim 18, wherein sending the invitation message comprises forming the invitation message with a Session Initiation Protocol (SIP) Uniform Resource Identifier (URI) usable for joining the network group.

24. A data-processing arrangement, comprising:
a network interface capable of communicating via a network;
a processor coupled to the network interface; and
a memory coupled to the processor, the memory having a group communication application that allows the user to communicate with an exclusive network communications group of data communications device users, the group communications application causing the processor to,
generate a single-use authentication token for use in joining the network communications group;
send to an invitee's communication device an invitation message including the single-use authentication token and a network location usable for joining the network group;
receive a request message from the invitee's communication device via the network, the request message containing the single-use authentication token;
confirm the single-use authentication token contained in the request message; and
in response to confirming the single-use authentication token, facilitate the invitee's communication device in joining the network communications group via a group application executing on the invitee's communication device.

25. The data-processing arrangement of claim 24, further comprising an advertising media, and wherein the group communications application causes the processor to send the invitation message to the invitee's communication device via the advertising media.

26. The data-processing arrangement of claim 25, wherein the advertising media comprises a near-field communications device.

27. The data-processing arrangement of claim 25, wherein the advertising media comprises a bar code.

28. The data-processing arrangement of claim 24, wherein the group communications application further causes the processor to:
associate the single-use authentication token with the advertised network location; and
after sending the invitation message to the invitee's communication device,
remove the association of the single-use authentication token with the advertised network location;
generate a new single-use authentication token for use in joining the network communications group; and
associate the new single-use authentication token with the advertised network location.

29. A processor-readable medium having instructions stored thereon which are executable by a data processing arrangement capable of being coupled to a network for communicating with an exclusive network communications group of data communications device users, the instructions executable by the data processing arrangement for performing steps comprising:
generating a single-use authentication token for use in joining the network communications group;
sending to an invitee's communication device an invitation message including the single-use authentication token and a network location usable forjoining the network group;
receiving a request message from the invitee's communication device via the network, the request message containing the single-use authentication token;
confirming the single-use authentication token contained in the request message; and
in response to confirming the single-use authentication token, facilitating the invitee's communication device in joining the network communications group via a group application executing on the invitee's communication device.

30. A system comprising:
means for generating a single-use authentication token for use in joining to an exclusive network communications group of communication device users;
means for sending to an invitee's communication device an invitation message including the single-use authentication token and a network location usable for joining the network group;
means for sending a request message to the network location from the invitee's communication device, the request message containing the single-use authentication token;
means for confirming the single-use authentication token in the request message received at the network location; and
means for facilitating the invitee's communication device in joining the network communications group via a group application executing on the invitee's communication device in response to confirming the single-use authentication token.
